(19) United States
(12) Patent Application Publication
(10) Pub. No.: US 2007/0200868 A1
(43) Pub. Date: Aug. 30, 2007

(54) Image synthesizing device

(75) Inventors: Manami Naito, Tokyo (JP); Yasunori Tsubaki, Tokyo (JP); Atsushi Tanaka, Tokyo (JP)

Correspondence Address: BIRCH STEWART KOLASCH & BIRCH, PO BOX 747, FALLS CHURCH, VA, 22040-0747, US

(73) Assignee: Mitsubishi Electric Corporation

(21) Appl. No.: 11/492,847

(22) Filed: Jul. 26, 2006

(30) Foreign Application Priority Data
Feb. 27, 2006 (JP) 2006-50749

(51) Int. Cl. G09G 5/02

(52) U.S. Cl. 345/592

(57) ABSTRACT

An image synthesizing device includes a graphics data expanding unit 2 for securing a rectangular area 4a whose alpha value is “0” in a region of a non-display memory 4, the region corresponding to a display area in which moving image data is to be displayed, and for expanding motionless graphics data onto a region of the non-display memory 4, the region corresponding to a display area in which the motionless graphics data is to be displayed, and a moving image data expanding unit 3 for expanding the moving image data onto a non-display memory 5. The image synthesizing device then synthesizes the graphics data which are expanded onto the non-display memory 4 and the graphics data which are expanded onto the non-display memory 5.

### BACKGROUND OF THE INVENTION

1. Field of the Invention

The present invention relates to an image synthesizing device which synthesizes a moving image, a still image, a character string, and the like.

2. Description of Related Art

In accordance with a related art image data synthesizing method, when superimposing still image data on moving image data, the still image data must be rearranged on the moving image data every time when the moving image data is updated, and the synthesized image cannot be updated otherwise.

On the other hand, if a rectangular area in which the still image data is arranged is managed as mask data, the synthesized image can be updated without rearranging the still image data on the moving image data even when the moving image data is updated.

However, since data which is not a rectangular still image, such as character string data, cannot be managed using such a rectangular area, it is necessary to rearrange the data such as character string data on the moving image data every time when the moving image data is updated.

The following patent reference 1 discloses image synthesizing device which provides a rectangular window in a still image, and which synthesizes a moving image and the still image so that the moving image is displayed in the rectangular window.

However, this related art image synthesizing device displays a moving image in a part of a still image, and differs from image synthesizing devices intended for superimposing still image data or character string data on moving image data to display a synthesized image.
[Patent reference 1] JP,7-306953,A (see paragraph numbers [0059] to [0060] and FIG. 11)

A problem with the related art image synthesizing device constructed as mentioned above is that while the management of complicated mask data corresponding to still image data makes it possible to eliminate the need for rearrangement of the still image data on moving image data even when the moving image data is updated, it is necessary to rearrange data which is not a rectangular still image, such as character string data, on the moving image data every time when the moving image data is updated since such data as character string data cannot be managed using a rectangular area.

### SUMMARY OF THE INVENTION

The present invention is made in order to solve the above-mentioned problem, and it is therefore an object of the present invention to provide an image synthesizing device which can display a synthesized image without rearranging such data as still image data, and character string data which are to be synthesized with moving image data every time when the moving image data is updated without managing complicated mask data.

In accordance with the present invention, there is provided an image synthesizing device including a graphics data expanding means for, when input graphics data to be synthesized is moving image data, securing a rectangular area whose transmittance information indicates perfect transparence in a region of a first non-display memory, the region corresponding to a display area in which the moving image data is to be displayed, and for, when the input graphics data to be synthesized is motionless graphics data, expanding the input graphics data onto a region of the first non-display memory, the region corresponding to a display area in which the motionless graphics data is to be displayed; a moving image data expanding means for, when the input graphics data to be synthesized is moving image data, expanding the moving image data onto a second non-display memory; and an image synthesizing means for synthesizing the graphics data which are expanded onto the first non-display memory by the graphics data expanding means, and the graphics data which are expanded onto the second non-display memory by the moving image data expanding means.

Therefore, the image synthesizing device in accordance with the present invention can display the synthesized image without managing complicated mask data and without rearranging the motionless graphics data every time when the moving image data is updated.

Further objects and advantages of the present invention will be apparent from the following description of the preferred embodiments of the invention as illustrated in the accompanying drawings.

### BRIEF DESCRIPTION OF THE DRAWINGS

FIG. 1 is a block diagram showing an image synthesizing device in accordance with embodiment 1 of the present invention; and

FIG. 2 is a diagram showing expanding processing carried out by a graphics data expanding unit 2 of the image synthesizing device in accordance with embodiment 1 of the present invention.

### DETAILED DESCRIPTION OF THE PREFERRED EMBODIMENTS

The preferred embodiments of the present invention will be now described with reference to the accompanying drawings.

### Embodiment 1

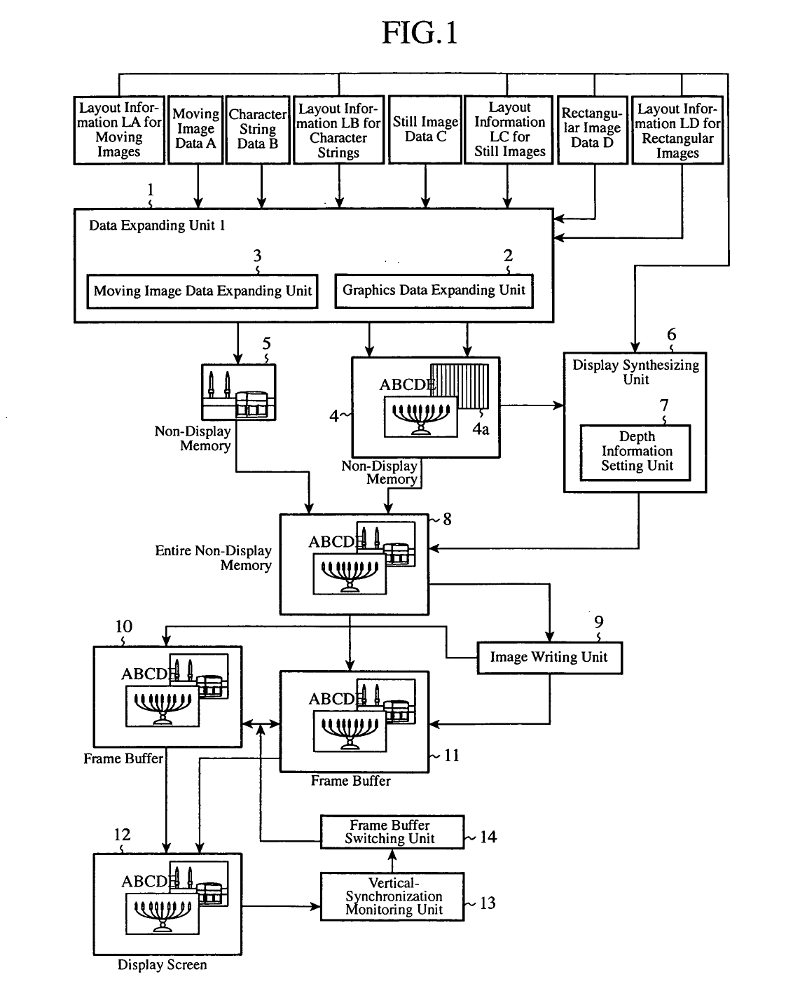

FIG. 1 is a block diagram showing an image synthesizing device in accordance with embodiment 1 of the present invention. The image synthesizing device shown in FIG. 1 receives, as graphics data to be synthesized, moving image data A, and also receives, as graphics data to be synthesized, motionless graphics data (e.g., character string data B, still image data C, and rectangular image data D), for example.

In the figure, a data expanding unit 1 is provided with a graphics data expanding unit 2 and a moving image data expanding unit 3, and provides the moving image data A to the moving image data expanding unit 3 and also provides both the character string data B, still image data C, and rectangular image data D, and layout information LA for moving images, layout information LB for character strings, layout information LC for still images, and layout information LD for rectangular images, to the graphics data expanding unit 2.

The layout information LA for moving images is the information indicating a display area (i.e., a display position in a display screen 12) in which the moving image data A is to be displayed, and the order in which the moving image data A is to be synthesized (i.e., a hierarchical relation with other images), the layout information LB for character strings is the information indicating a display area and in which the character string data B is to be displayed and the order in which the character string data B is to be synthesized, the layout information LC for still images is the information indicating a display area in which the still image data C is to be displayed and the order in which the still image data C is to be synthesized, and the layout information LD for rectangular images is the information indicating a display area in which the rectangular image data D is to be displayed and the order in which the rectangular image data D is to be synthesized.

The graphics data expanding unit 2 of the data expanding unit 1 secures a rectangular area 4a whose alpha value (transmittance information) is zero (alpha value=0 means that the transmittance information indicates perfect transparence) in a region of a non-display memory 4, the region corresponding to a display area in which the moving image data A is to be displayed, and carries out a process of expanding the motionless graphics data (i.e., the character string data B, still image data C, and rectangular image data D) with the alpha value alpha onto another region of the non-display memory 4, the other region corresponding to the motionless graphics data (i.e., the character string data B, still image data C, and rectangular image data D). The graphics data expanding unit 2 constitutes a graphics data expanding means.

The moving image data expanding unit 3 of the data expanding unit 1 carries out a process of expanding the moving image data A onto a non-display memory 5 every time when the moving image data A is updated. The moving image data expanding unit 3 constitutes a moving image data expanding means.

The non-display memory 4 is a first non-display memory in which the rectangular area 4a whose alpha value is zero is secured by the graphics data expanding unit 2, and which stores the graphics data (i.e., the character string data B, still image data C, and rectangular image data D) expanded by the graphics data expanding unit 2.

The non-display memory 5 is a second non-display memory which stores the moving image data A expanded by the moving image data expanding unit 3.

A display synthesizing unit 6 transmits the moving image data A expanded onto the non-display memory 5 to a region of an entire non-display memory 8, the region corresponding to the display area in which the moving image data A is to be displayed, and then transmits the graphics data which are expanded onto the non-display memory 4 in which the rectangular area 4a having an alpha value of zero is secured in the region corresponding to the display area in which the moving image data A is to be displayed to the entire non-display memory 8. After that, the display synthesizing unit 6 carries out a process of synthesizing the graphics data which are expanded onto the non-display memory 4 by the graphics data expanding unit 2 and the graphics data which are expanded onto the non-display memory 5 by the moving image data expanding unit 3. The display synthesizing unit 6 constitutes an image synthesizing means.

A depth information setting unit 7 carries out a process of adjusting a depth value associated with the moving image data expanded onto the non-display memory 5 when the display synthesizing unit 6 synthesizes the graphics data which expanded onto the non-display memory 4 and the graphics data which are expanded onto the non-display memory 5.

The entire non-display memory 8 is a memory for storing the image data synthesized by the display synthesizing unit 6.

An image writing unit 9 carries out a process of transmitting the synthesized image data stored in the entire non-display memory 8 to either a frame buffer 10 or a frame buffer 11. In other words, the image writing unit 9 carries out a process of transmitting the synthesized image data to one of the frame buffers in which image data not currently being displayed is stored.

A display screen 12 is the screen of a display not shown in the figure, and displays the synthesized image data written into either the frame buffer 10 or the frame buffer 11.

A vertical-synchronization monitoring unit 13 carries out a process of monitoring a vertical synchronizing signal for controlling the vertical synchronization of the display screen 12.

A frame buffer switching unit 14 switches between the frame buffer 10 and the frame buffer 11 in synchronization with the vertical synchronizing signal monitored by the vertical-synchronization monitoring unit 13 so as to carry out a process of displaying the synthesized image data currently written in the selected frame buffer on the display screen 12.

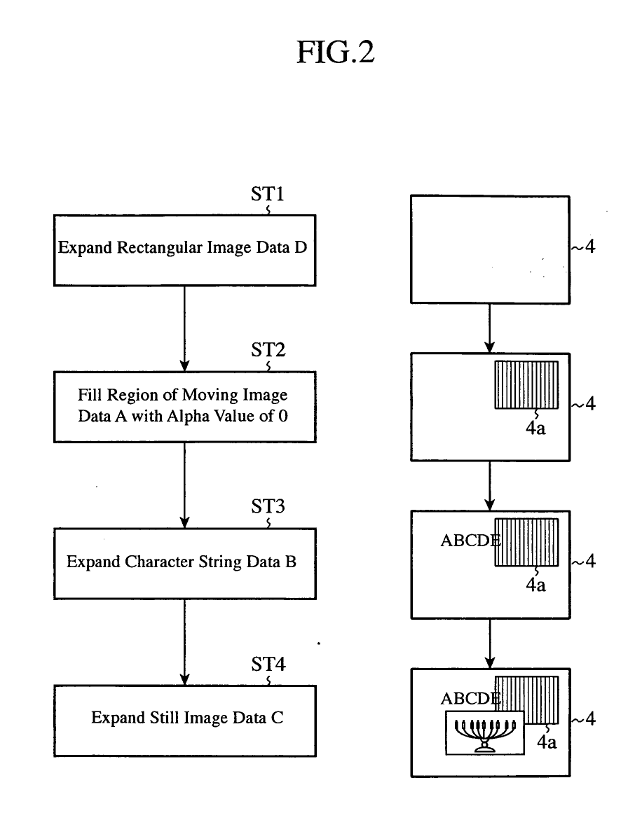

FIG. 2 is a diagram showing expanding processing carried out by the graphics data expanding unit 2 of the image synthesizing device in accordance with embodiment 1 of the present invention.

Next, the operation of the image synthesizing device in accordance with this embodiment of the present invention will be explained.

In this embodiment 1, assume that the display screen 12 has a screen size of 1024×768, the moving image data A has 320×240 pixels, and the coordinates of the starting point of a display area in which the moving image data is displayed is (600,100).

Furthermore, assume that the coordinates of the starting point of a display area in which the character string data B is displayed is (200,200), and the character string data B is “ABCDE” which is displayed in an area having a height of 100 and a width of 500.

In addition, assume that the still image data C has 400×300 pixels, and the coordinates of the starting point of a display area in which the still image data C is displayed is (200,400).

Furthermore, assume that the rectangular image data D has 1024×768 pixels (which are the same as the size of the display screen 12), and is data which fills a specific area with a 32-bit color of ARGB (255, 255, 128, 128).

In this embodiment 1, the moving image data A, character string data B, still image data C, and rectangular image data D are synthesized in the following order:
Rectangular image data D→moving image data A→character string data B→still image data C

As previously explained, information about the order in which these images are synthesized, information about the display positions of the images, etc. are contained in the layout information LA for moving images, layout information LB for character strings, layout information LC for still images, and layout information LD for rectangular images.

First, when receiving the moving image data A, character string data B, still image data C, rectangular image data D, layout information LA for moving images, layout information LB for character strings, layout information LC for still images, and layout information LD for rectangular images, the data expanding unit 1 furnishes the moving image data A to the moving image data expanding unit 3, and provides both the character string data B, still image data C and rectangular image data D, and the layout information LA for moving images, layout information LB for character strings, layout information LC for still images, and layout information LD for rectangular images to the graphics data expanding unit 2.

When receiving both the character string data B, still image data C, and rectangular image data D, and the layout information LA for moving images, layout information LB for character strings, layout information LC for still images, and layout information LD for rectangular images, the graphics data expanding unit 2 of the data expanding unit 1 refers to the information about the order in which the images are synthesized, which is included in the plural pieces of layout information L, and recognizes that the moving image data A, character string data B, still image data C, rectangular image data D are synthesized in the order of rectangular image data D→moving image data A→character string data B→still image data C.

When recognizing that the rectangular image data D is to be displayed at the bottom, the graphics data expanding unit 2 expands the rectangular image data D onto the non-display memory 4 according to the information about the display position of the rectangular image data D which is included in the layout information LD for rectangular images (in step ST1).

When then recognizing that the moving image data A is to be displayed immediately above the rectangular image data D, the graphics data expanding unit 2 refers to the information about the display position of the moving image data A which is included in the layout information LA for moving images, specifies a region of the non-display memory 4, the region corresponding to the display area in which the moving image data A is to be displayed, and fills the region with an alpha value of “0” so as to secure a rectangular region 4a having an alpha value of zero in the region of the non-display memory 4, the region corresponding to the display area in which the moving image data A is to be displayed (in step ST2).

When then recognizing that the character string data B is to be displayed immediately above the moving image data A, the graphics data expanding unit 2 expands character string data B onto the non-display memory 4 according to the information about the display position of the character string data B, which is included in the layout information LB for character strings (in step ST3).

Furthermore, when then recognizing that the still image data C is to be displayed immediately above the character string data B, the graphics data expanding unit 2 expands the still image data C in the non-display memory 4 according to the information about the display position of the still image data C which is included in the layout information LC for still images (in step ST4).

When receiving the moving image data A, the moving image data expanding unit 3 of the data expanding unit 1 expands the moving image data A onto the non-display memory 5.

Even if the moving image data A is updated, the graphics data expanding unit 2 does not repeatedly carry out a process of expanding the other image data onto the non-display memory 4. In contrast, ever time when the moving image data A is updated, the moving image data expanding unit 3 expands the moving image data A onto the non-display memory 5.

When the graphics data expanding unit 2 completes its expanding processing and the moving image data expanding unit 3 completes its expanding processing, the display synthesizing unit 6 transfers the moving image data A expanded onto the non-display memory 5 to the region of the entire non-display memory 8, the region corresponding to the display area in which the moving image data A is to be displayed, as shown in FIG. 1, transfers the graphics data which are expanded onto the non-display memory 4 in which the rectangular area 4a having an alpha value of “0” is secured in the region corresponding to the display area in which the moving image data A is to be displayed to the entire non-display memory 8, and then synthesizes the graphics data which are expanded onto the non-display memory 4 by the graphics data expanding unit 2, and the graphics data which are expanded onto the non-display memory 5 by the moving image data expanding unit 3.

In this case, although the rectangular region 4a having an alpha value of “0” is superimposed on the moving image data A expanded onto the entire non-display memory 8, the moving image data A is displayed in the rectangular region 4a since the rectangular region 4a having an alpha value of “0” enables any image thereunder to appear on the surface thereof.

However, when the display synthesizing unit 6 synthesizes the graphics data which are expanded onto the non-display memory 4, and the graphics data which are expanded onto the non-display memory 5, the depth information setting unit 7 receives the setting of the depth value of the moving image data expanded by the non-display memory 5, and adjusts the depth of the moving image data according to the setting of the depth value.

Therefore, the image synthesizing device can display the moving image data A at a position near the surface of the display screen 12, or can display the moving image data A at a position deep in the display screen 12 according to the liking of the user.

When the display synthesizing unit 6 synthesizes the image data on the entire non-display memory 8, the image writing unit 9 transfers the synthesized image data stored in the entire non-display memory 8 to either the frame buffer 10 or the frame buffer 11.

In other words, the image writing unit 9 transfers the synthesized image data to one of the frame buffers which is not being currently selected by the frame buffer switching unit 14 (i.e., the frame buffer in which the image data currently not being displayed is stored).

Every time when the vertical-synchronization monitoring unit 13 detects the vertical synchronizing signal for controlling the vertical synchronization of the display screen 12, the frame buffer switching unit 14 switches between the frame buffer 10 and the frame buffer 11 so as to display the synthesized image data currently being written into the frame buffer selected by the frame buffer switching unit 14 on the display screen 12 in synchronization with the vertical synchronizing signal.

As a result, the image synthesizing device of this embodiment can display the synthesized image data without causing flickers.

As can be seen from the above description, the image synthesizing device in accordance with this embodiment 1 includes the graphics data expanding unit 2 for, when input graphics data to be synthesized is moving image data, securing a rectangular area 4a having an alpha value of “0” in a region of the non-display memory 4, the region corresponding to the display area in which the moving image data is to be displayed, and for, when the input graphics data to be synthesized is motionless graphics data, expanding the graphics data onto a region of the non-display memory 4, the region corresponding to the display area in which the graphics data is to be displayed, the moving image data expanding unit 3 for, when the input graphics data to be synthesized is moving image data, expanding the moving image data onto the non-display memory 5, and the display synthesizing unit 6 for synthesizing the graphics data which are expanded onto the non-display memory 4, and the graphics data which are expanded onto the non-display memory 5. Therefore, the image synthesizing device can display the synthesized image without managing complicated mask data and without rearranging the motionless graphics data every time when the moving image data is updated.

In addition, in accordance with this embodiment 1, when the display synthesizing unit 6 synthesizes the graphics data which are expanded onto the non-display memory 4, and the graphics data which are expanded onto the non-display memory 5, the depth information setting unit 7 adjusts the depth of the moving image data expanded onto the non-display memory 5. Therefore, the image synthesizing device can display the moving image data A at a position near the surface of the display screen 12, or can display the moving image data A at a position deep in the display screen 12.

It is clear that the image writing unit 9 can carry out scaling of each image data and a process of providing a scrolling effect by changing the position where each image data is transferred and the rectangular size of each image data.

Many widely different embodiments of the present invention may be constructed without departing from the spirit and scope of the present invention. It should be understood that the present invention is not limited to the specific embodiments described in the specification, except as defined in the appended claims.

What is claimed is:

1. An image synthesizing device comprising:
a graphics data expanding means for, when input graphics data to be synthesized is moving image data, securing a rectangular area whose transmittance information indicates perfect transparence in a region of a first non-display memory, the region corresponding to a display area in which said moving image data is to be displayed, and for, when the input graphics data to be synthesized is motionless graphics data, expanding said input graphics data onto a region of said first non-display memory, the region corresponding to a display area in which said motionless graphics data is to be displayed;
a moving image data expanding means for, when the input graphics data to be synthesized is moving image data, expanding said moving image data onto a second non-display memory; and
an image synthesizing means for synthesizing the graphics data which are expanded onto said first non-display memory by said graphics data expanding means, and the graphics data which are expanded onto said second non-display memory by said moving image data expanding means.

2. The image synthesizing device according to claim 1, wherein when transferring moving image data which is expanded onto said second non-display memory to a region of an entire non-display memory, the region corresponding to the display area in which the moving image data is to be displayed, said image synthesizing means transfers the graphics data which are expanded onto said first non-display memory in which the rectangular area whose transmittance information indicates perfect transparence is secured in the region corresponding to the display area in which said moving data is to be displayed to said entire non-display memory.

3. The image synthesizing device according to claim 1, wherein every when said moving image data is updated, said moving image data expanding means expands said moving image data onto said second non-display memory.

4. The image synthesizing device according to claim 1, wherein when synthesizing the graphics data which are expanded onto said first non-display memory and the graphics data which are expanded onto said second non-display memory, said image synthesizing means adjusts a depth value of said moving image data which are expanded onto said second non-display memory.
